(19) United States
(12) Patent Application Publication
(10) Pub. No.: US 2019/0015275 A1
(43) Pub. Date: Jan. 17, 2019

(54) HOSPITAL BED AND GAS MATTRESS UNIT FOR HOSPITAL BED

(71) Applicant: CHIH-HUI CHENG, TAIPEI CITY (TW)

(72) Inventor: CHIH-HUI CHENG, TAIPEI CITY (TW)

(21) Appl. No.: 15/647,375

(22) Filed: Jul. 12, 2017

(51) Int. Cl. A61G 7/057; A61G 7/05

(52) U.S. Cl. CPC A61G 7/057; A61G 7/052; A61G 7/0501; A61G 7/05769

(57) ABSTRACT

A hospital bed comprises gas mattress units, connecting pipe devices and a gas supplying-releasing device. The gas mattress units each have an inner layer and an outer layer. The inner layer is an airbag. The outer layer is a laminated fabric. The laminated fabric encloses the airbag. The airbag internally defines a first gas receiving space. A second gas receiving space is defined between the laminated fabric and the airbag. The connecting pipe devices and the gas supplying-releasing device are in communication with the gas mattress units, allowing a gas to be introduced into and released from the first gas receiving space. The first and second gas receiving spaces enable the hospital bed to bear high internal pressure and thus be durable, thereby lessening the durability requirement of the laminated fabric.

### FIELD OF THE INVENTION

The present invention relates to medical equipment and, more particularly, to a hospital bed and a gas mattress unit for hospital beds.

### BACKGROUND OF THE INVENTION

Conventional hospital beds, especially those hospital beds for use by bedridden or physically disabled patients, are usually designed to prevent pressure ulcers (commonly known as bed sores). To this end, hospital bed manufacturers developed hospital air beds. The hospital air beds are each in communication with a pneumatic pump through a connecting pipe so that the pneumatic pump inflates (pressurizes) or deflates (depressurizes) the hospital air beds.

The conventional hospital air beds are mostly made of nylon fabric, particularly monolayer nylon fabric, to enclose a closed gas receiving space, thereby defining an airbag. The reason why the conventional hospital air beds are mostly made of nylon fabric is as follows: hospital air beds made of nylon fabric surpasses those made of any other materials in bearing internal pressure and thus abiding by laws governing strict safety requirements of medical equipment. However, the process for manufacturing the conventional hospital air beds made of nylon fabric is intricate and thus incurs high costs. Furthermore, colors of nylon fabric are too limited to render the conventional hospital air beds thus made variable in appearance and aesthetically pleasing.

### SUMMARY OF THE INVENTION

It is an objective of the present invention to provide a hospital bed and a gas mattress unit for the hospital bed, which surpasses conventional hospital air beds in bearing internal pressure and thus not getting damaged.

Another objective of the present invention is to provide a hospital bed and a gas mattress unit for the hospital bed, which can be made of a wide variety of materials, easy to make, incur low costs, and are aesthetically pleasing.

In order to achieve the above and other objectives, the present invention provides a hospital bed, comprising a plurality of gas mattress units, a plurality of connecting pipe devices and a gas supplying-releasing device.

The gas mattress units each have an inner layer and an outer layer. The inner layer is an airbag. The airbag internally defines a first gas receiving space. The outer layer is a laminated fabric. The laminated fabric encloses the airbag and thereby defines a second gas receiving space between the airbag and the laminated fabric. The gas mattress units are connected to each other. The connecting pipe devices are each disposed on a surface of a corresponding one of the airbags in such a manner that the surface is not covered with the laminated fabric. The gas supplying-releasing device is in communication with the connecting pipe devices, allowing a gas to be introduced into and released from the first gas receiving space.

In an embodiment of the hospital bed according to the present invention, the airbag is coated by a surface layer of thermoplastic urethane (TPU).

In an embodiment of the hospital bed according to the present invention, the airbag is coated by a surface layer of polyvinyl chloride (PVC), polyethylene (PE), polyurethane (PU), thermplastic elastomer (TPE), thermplastic rubber (TPR) or ethylene vinyl acetate (EVA).

In an embodiment of the hospital bed according to the present invention, the gas mattress units equal the connecting pipe devices in quantity, the gas mattress units being in a number of 20, 21 or 22, and the connecting pipe devices being in a number of 20, 21 or 22.

In an embodiment of the hospital bed according to the present invention, the laminated fabric is laminated to the airbags by sewing.

In an embodiment of the hospital bed according to the present invention, the second gas receiving space are provided in a plural number.

In order to achieve the above and other objectives, the present invention provides a gas mattress unit for hospital beds, the gas mattress unit having an inner layer and an outer layer, the inner layer being an airbag internally defining a first gas receiving space, and the outer layer being a laminated fabric enclosing the airbag, thereby defining a second gas receiving space between the airbag and the laminated fabric.

In an embodiment of the gas mattress unit according to the present invention, the airbag is coated by a surface layer of thermoplastic urethane (TPU).

In an embodiment of the gas mattress unit according to the present invention, the airbag is coated by a surface layer of polyvinyl chloride (PVC), polyethylene (PE), polyurethane (PU), thermplastic elastomer (TPE), thermplastic rubber (TPR) or ethylene vinyl acetate (EVA).

In an embodiment of the gas mattress unit according to the present invention, the laminated fabric is laminated to the airbags by sewing.

In an embodiment of the gas mattress unit according to the present invention, the second gas receiving space are provided in a plural number.

Separation of the first gas receiving space 12 and the second gas receiving space 14 is not only rendered feasible by the airbag 11 (inner layer) and the laminated fabric 13 (outer layer) but also enables the receiving spaces to bear internal pressure (arising from the patient lying on the hospital bed) optimally. As a result, the hospital bed and the gas mattress unit of the present invention are durable enough to pass every strict pressure test and thereby outperform the conventional hospital air beds (each characterized by a monolayer structure and equipped with just one single gas receiving space) in terms of capability to bear internal pressure. As indicated above, structural features of the aforesaid bilayer receiving spaces lessen durability requirement of the laminated fabric. Therefore, the laminated fabric of the hospital bed and the gas mattress unit of the present invention is not necessarily made of nylon, thereby allowing the manufacturing of the hospital bed and the gas mattress unit of the present invention to be easy and cost-effective. In addition to their aforesaid advantages, the hospital bed and the gas mattress unit of the present invention can be made of aesthetically pleasing laminated fabric.

### BRIEF DESCRIPTION OF THE DRAWINGS

Objectives, features, and advantages of the present invention are hereunder illustrated with specific embodiments in conjunction with the accompanying drawings, in which:

FIG. 1 is a perspective view of a hospital bed according to an embodiment of the present invention;

FIG. 2 is a partial perspective view of the hospital bed according to an embodiment of the present invention; and

FIG. 3 is a partial cross-sectional view of a gas mattress unit of the hospital bed according to an embodiment of the present invention.

### DETAILED DESCRIPTION OF THE PREFERRED EMBODIMENTS

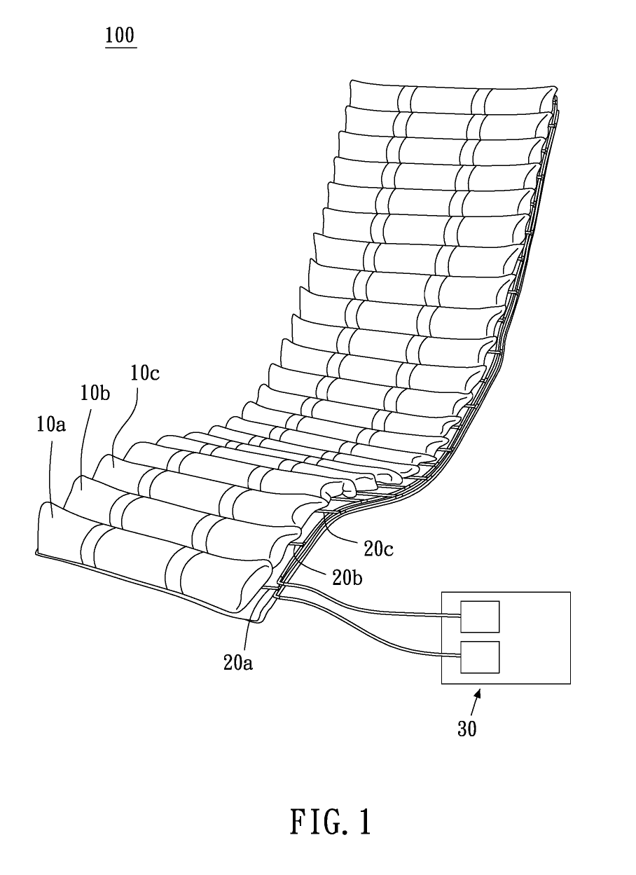

Referring to FIG. 1, there is shown a perspective view of a hospital bed 100 according to an embodiment of the present invention. The hospital bed 100 is for use by bedridden or physically disabled patients to protect them against pressure ulcers (commonly known as bed sores), but the hospital bed 100 is not restricted to the aforesaid purpose.

As shown in FIG. 1, the hospital bed 100 comprises a plurality of gas mattress units 10, a plurality of connecting pipe devices 20 and a gas supplying-releasing device 30. The gas mattress units 10 are connected to each other and thereby underpin a patient lying thereon; however, the patient does not necessarily take an incumbent posture.

In this embodiment, the gas mattress units 10 are provided in the number of 22 (and denoted by 10a, 10b, 10c . . . , respectively). Likewise, the connecting pipe devices 20 are provided in the number of 22 (and denoted by 20a, 20b, 20c . . . , respectively). The gas mattress units 10 are connected to the gas supplying-releasing device 30 by the connecting pipe devices 20 in such a manner that the gas mattress units 10 are in a one-to-one relationship with the connecting pipe devices 20. The gas supplying-releasing device 30 comprises one or more pneumatic pumps. For example, the gas mattress unit 10a is connected to the gas supplying-releasing device 30 by the connecting pipe device 20a. For example, the gas mattress unit 10b is connected to the gas supplying-releasing device 30 by the connecting pipe device 20b.

The gas supplying-releasing device 30 supplies a gas to and releases the gas from the gas mattress units 10 in different ways. For instance, in an embodiment, the gas is introduced into a first gas mattress unit 10a to the full. Then, the second gas mattress unit 10b is filled with the gas fully while the first gas mattress unit 10b deflates. The aforesaid inflating and deflating process takes place until the last gas mattress unit is filled with the gas to the full. Alternatively, after the last gas mattress unit has been filled with the gas, the aforesaid cycle starts anew to inflate the first gas mattress unit 10a and deflate the last gas mattress unit.

In this embodiment, the gas supplying-releasing device 30 comprises two pneumatic pumps. One pneumatic pump connects with odd-numbered gas mattress units and thereby inflates/deflates them. The other pneumatic pump connects with even-numbered gas mattress units and thereby inflates/deflates them.

Persons skilled in the art understand that the aforesaid disclosure is merely directed to a preferred embodiment of the present invention and thus may be changed or modified in any variant embodiment of the present invention.

For instance, in a variant embodiment of the present invention, the gas mattress units 10 are provided in the number of 20 or 21 and the connecting pipe devices 20 in the number of 20 or 21, respectively. In another variant embodiment of the present invention, the connecting pipe devices 20 do not equal the gas mattress units 10 in quantity (for example, the former is two times more than the latter.)

In yet another variant embodiment of the present invention, the shapes and positions of the gas mattress units 10, connecting pipe devices 20 and gas supplying-releasing device 30 are subject to changes as needed, so are the sequence and degree of inflating the gas mattress units 10.

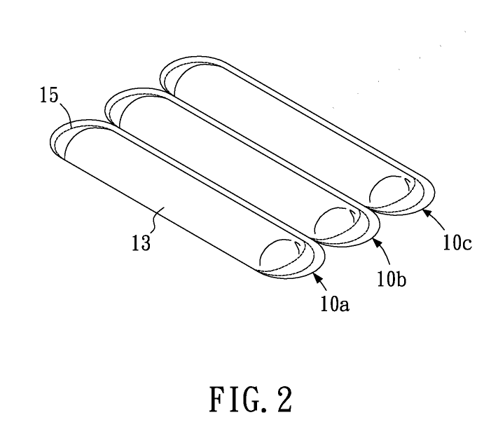

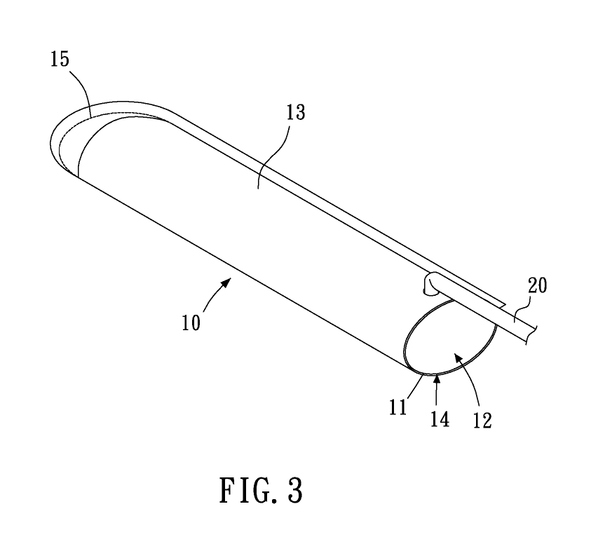

FIG. 2 is a partial perspective view of the hospital bed 100 according to an embodiment of the present invention. FIG. 3 is a partial cross-sectional view of the gas mattress unit 10 of the hospital bed 100 according to an embodiment of the present invention.

Referring to FIG. 2 and FIG. 3, the gas mattress unit 10 of the hospital bed 100 has an inner layer and an outer layer. The inner layer is an airbag 11. The airbag 11 internally defines a first gas receiving space 12. The outer layer is a laminated fabric 13. The laminated fabric 13 encloses the airbag 11 so that a second gas receiving space 14 is defined between the airbag 11 and the laminated fabric 13. The connecting pipe devices 20 are disposed on a surface of the airbag 11 of the gas mattress unit 10 in such a manner that the surface is not covered with the laminated fabric 13. In this embodiment, the laminated fabric 13 is laminated to the airbag 11 by sewing, and thus the surface of the laminated fabric 13 reveals a sewing thread 15. The second gas receiving space 14 is provided in the number of one or a plural number, depending on the sewing pattern.

In a variant embodiment, the laminated fabric 13 is laminated to the airbag 11 not by sewing, as, for example, the laminated fabric 13 has a zipper and fits around the airbag 11 (in the same way as a pillow case fits around a pillow) before being zipped up.

The airbag 11 is coated by a surface layer of thermoplastic urethane (TPU) to maximize the safety coefficient of the gas mattress unit 10 and its capability to bear high internal pressure. Alternatively, the airbag 11 is coated by a surface layer of one of polyvinyl chloride (PVC), polyethylene (PE), polyurethane (PU), thermplastic elastomer (TPE), thermplastic rubber (TPR) and ethylene vinyl acetate (EVA).

Separation of the first gas receiving space 12 and the second gas receiving space 14 is not only rendered feasible by the airbag 11 (inner layer) and the laminated fabric 13 (outer layer) but also enables the receiving spaces to bear internal pressure (arising from the patient lying on the hospital bed) optimally. As a result, the hospital bed and the gas mattress unit of the present invention are durable enough to pass every strict pressure test and thereby outperform the conventional hospital air beds (each characterized by a monolayer structure and equipped with just one single gas receiving space) in terms of capability to bear internal pressure.

As indicated above, structural features of the aforesaid bilayer receiving spaces comply with laws governing strict safety requirements of medical equipment and thereby and lessen durability requirement of the laminated fabric. Therefore, the laminated fabric of the hospital bed and the gas mattress unit of the present invention is not necessarily made of nylon, thereby allowing the manufacturing of the hospital bed and the gas mattress unit of the present invention to be easy and cost-effective. In addition to their aforesaid advantages, the hospital bed and the gas mattress unit of the present invention can be made of aesthetically pleasing laminated fabric.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

1. A hospital bed, comprising:
a plurality of gas mattress units each having an inner layer and an outer layer, the inner layer being an airbag internally defining a first gas receiving space, and the outer layer being a laminated fabric enclosing the airbag, thereby defining a second gas receiving space between the airbag and the laminated fabric, with the gas mattress units connected;
a plurality of connecting pipe devices each disposed on a surface of a corresponding one of the airbags in such a manner that the surface is not covered with the laminated fabric; and
a gas supplying-releasing device in communication with the connecting pipe devices, allowing a gas to be introduced into and released from the first gas receiving space;
wherein the airbag is coated by a surface layer of thermoplastic urethane (TPU).

2-3. (canceled)

4. The hospital bed of claim 1, wherein the gas mattress units equal the connecting pipe devices in quantity, the gas mattress units being in a number of one of 20, 21 and 22, and the connecting pipe devices being in a number of one of 20, 21 and 22.

5. The hospital bed of claim 1, wherein the laminated fabric is laminated to the airbags by sewing.

6. The hospital bed of claim 1, wherein the second gas receiving spaces are provided in a plural number.

7. A gas mattress unit for hospital beds, the gas mattress unit having an inner layer and an outer layer, the inner layer being an airbag internally defining a first gas receiving space, and the outer layer being a laminated fabric enclosing the airbag, thereby defining a second gas receiving space between the airbag and the laminated fabric; wherein the airbag is coated by a surface layer of thermoplastic urethane (TPU).

8-9. (canceled)

10. The gas mattress unit of claim 7, wherein the laminated fabric is laminated to the airbag by sewing.

11. The gas mattress unit of claim 7, wherein the second gas receiving spaces are provided in a plural number.
